(19) United States
(12) Patent Application Publication
(10) Pub. No.: US 2025/0326640 A1
(43) Pub. Date: Oct. 23, 2025

(54) PROCESS FOR PRODUCING HYDROGEN BIS(CHLOROSULFONYL)IMIDE

(71) Applicant: SPECIALTY OPERATIONS FRANCE, Lyon (FR)

(72) Inventor: Etienne Schmitt, Soucieu-En-Jarrest (FR)

(73) Assignee: SPECIALTY OPERATIONS FRANCE, Lyon (FR)

(21) Appl. No.: 18/871,086

(22) PCT Filed: May 30, 2023
(86) PCT No.: PCT/EP2023/064381

§ 371 Date: Dec. 2, 2024

(30) Foreign Application Priority Data
Jun. 1, 2022 (EP) 22305803.3

(51) Int. Cl. C01B 21/093; B01D 3/10; B01D 3/14

(52) U.S. Cl. CPC C01B 21/093; B01D 3/10; B01D 3/143

(57) ABSTRACT

The present invention relates to a process for manufacturing hydrogen bis(chlorosulfonyl)imide (HCSI), said process comprising following steps: (i) providing to a reactor a composition (H) comprising chlorosulfonyl isocyanate in an amount (CSI-1), chlorosulfonic acid in an amount (CSA-1) and HCSI in an amount (HCSI-1) of most 20 wt. % based on the total weight of composition (H), and (ii) heating said composition (H). The present invention also relates to a method for recycling a composition (H) as defined above, said method comprising feeding said composition (H) to a reactor, and heating said composition (H) at a temperature below 150° C.

### CROSS-REFERENCE TO RELATED APPLICATION

This application claims priority to earlier European Patent Application no. 22305803.3 filed on Jun. 1, 2022, the whole content of this application being hereby incorporated by reference for all purposes.

### TECHNICAL FIELD

The present disclosure relates to a process for producing hydrogen bis(chlorosulfonyl)imide (HCSI).

### BACKGROUND ART

Hydrogen bis(fluorosulfonyl)imide (HFSI), its corresponding salts and ionic liquids comprising the FSI anion have been shown to be useful in a wide variety of applications including, but not limited to, as electrolytes in lithium ion batteries and ultracapacitors. Hydrogen bis(fluorosulfonyl)imide is a relatively strong acid and forms various stable metal salts. The lithium salt of bis(fluorosulfonyl)imide (LiFSI) has shown to be particularly useful in batteries and ultracapacitors. It is known that hydrogen bis(chlorosulfonyl)imide (HCSI) is the most important starting material for the manufacture of HFSI.

There are many processes for producing HCSI. One of the known processes is called “isocyanate route”, which comprises the steps of (i) reacting chlorosulfonyl isocyanate with chlorosulfonic acid to prepare a reaction mixture comprising HCSI, heavy fraction and light fraction, and (ii) distilling said reaction mixture to separate each of the light fraction, HCSI and heavy fraction.

As obtained at the end of this process, the isolated light fraction is a dangerous waste, as it is highly corrosive. Thus, the waste management cost of the current isocyanate route is relatively high.

CN Patent Application No. 106044728 (in the name of QUZHOU CHEMSPEC CHEMICAL CO., LTD.) teaches a preparation method of imido-disulfuryl fluoride lithium salt. Example 4 indicates HCSI was produced through the isocyanate route. Specifically, chlorosulfonic acid was mixed with concentrated sulfuric acid and the mixture was heated to 105-115° C. Then, chlorosulfonyl isocyanate was added dropwise. After the addition, the temperature was gradually raised up to 120-1301. Only the excess of chlorosulfonyl isocyanate was separated from the main fraction for recycling, and most of the fraction was left untreated after the reaction.

WO 2009/123328 (Nippon Catalytic Chem Ind) provide a method for producing fluorosulfonylimides such as N-(fluorosulfonyl)-N-(fluoroalkylsulfonyl)imide, di(fluorosulfonyl)imide and salts thereof, said method comprising a fluorination step of a chlorinated precursor. Example 2 of this document teaches a preparation method of hydrogen bis(chlorosulfonyl)imide (HCSI) by reaction of chlorosulfonic acid (CSA) with chlorosulfonyl isocyanate (CSI), whereas the target hydrogen bis(chlorosulfonyl)imide (HCSI) is isolated from the reaction medium by distillation under reduced pressure.

### SUMMARY OF THE INVENTION

The Applicant perceived that there is still the need for an improved environmentally friendly process for producing HCSI, which features easy handling and recycling of light fractions, as well as low production of non-recycled/non-recyclable products, low waste-management cost, while increasing the HCSI yield.

It has now been discovered that a composition (H) comprising chlorosulfonyl isocyanate, chlorosulfonic acid and HCSI, previously considered as a waste stream after isolation from the reaction mixture of isocyanate route above mentioned, can be used for manufacturing HCSI.

The Applicant unexpectedly found that the recycling of such composition (H) for the synthesis of HCSI, successfully increases the final yield of HCSI. Advantageously, the Applicant found that composition (H) can be either recycled in complement of fresh chlorosulfonyl isocyanate and chlorosulfonic acid or used as such to manufacture HCSI without the use of further reactants.

### BRIEF DESCRIPTION OF DRAWINGS

FIG. 1 Comparison of DSC results from HCSI synthesised in Examples 1 to 4.

### DETAILED DESCRIPTION

In the present application:
the expression “between . . . and . . . ” should be understood as including the limits;
any description, even though described in relation to a specific embodiment, is applicable to and interchangeable with other embodiments of the present invention;
the expression “isocyanate route” is intended to indicate the reaction comprising at least the steps of (i) reacting chlorosulfonyl isocyanate with chlorosulfonic acid to prepare a reaction mixture comprising HCSI, heavy fraction and light fraction, and (ii) distilling said reaction mixture to separate each of the light fraction, HCSI and heavy fraction;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

In a first aspect, the present invention relates to a process for manufacturing hydrogen bis(chlorosulfonyl)imide (HCSI), said process comprising the following steps:
(i) providing to a reactor a composition (H) comprising chlorosulfonyl isocyanate in an amount (CSI-1), chlorosulfonic acid in an amount (CSA-1) and HCSI in an amount (HCSI-1) of most 20 wt. % based on the total weight of composition (H), and
(ii) heating said composition (H), thus obtaining a mixture (M1) comprising HCSI in an amount (HCSI-2), wherein (HCSI-2) is higher than (HCSI-1).

Preferably, the molar ratio of chlorosulfonyl isocyanate in amount (CSI-1) and chlorosulfonic acid in amount (CSA-1) is equal for example to 1.00:1.01, 1.00:1.02, 1.00:1.03, 1.00:1.04, 1.00:1.05, 1.00:1.06, 1.00:1.07, 1.00:1.08, 1.00:1.09, 1.00:1.10 or any range between these values.

Preferably, composition (H) comprises HCSI in an amount (HCSI-1) of at most 15 wt. %, more preferably at most 12 wt. %, at most 10 wt. %, at most 8 wt. %, at most 5 wt. %, at most 2 wt. % or at most 1 wt. %, based on the total weight of composition (H).

Preferably, composition (H) comprises HCSI in an amount (HCSI-1) of at least 0.01 wt. %, more preferably at least 0.05 wt. %, based on the total weight of composition (H).

The presence and the amounts of CSA, CSI and HCSI in composition (H), as well as in the other compositions mentioned in the present description, can be determined for example using spectroscopic analytical techniques, such as Raman or Near-IR.

Advantageously, said composition (H) is isolated from one or more reaction mixture(s) of isocyanate route, as defined above. Said composition (H) can be also referred to as “a light fraction”. Thus, advantageously, the process according to the present disclosure significantly reduces the waste management cost of isocyanate route, since the light fraction separated is recycled and reused.

Composition (H) can be heated in step (ii) in the presence or absence of an additional catalyst.

Optionally, composition (H) is heated in the presence of a catalyst.

Said catalyst is not particularly limited. Said catalyst can be an acid and preferably a protic acid and/or a Lewis acid. The Lewis acid is generally based on Lewis acid-base theory and generally refers to a substance that accepts an electron pair. Said Lewis acids can be selected from the group consisting of NiCl₂, FeCl₂, FeCl₃, CoCl₃, ZnCl₂ and MnCl₂. The protic acid generally refers to molecules or ions that can release protons (hydrogen ions, H+). Said protic acid can be concentrated sulfuric acid and/or fuming sulfuric acid. The concentrated sulfuric acid generally refers to a sulfuric acid solution having a mass percentage of 70%, more specifically a sulfuric acid solution having a mass percentage of 98%. The fuming sulfuric acid (HSO₄·xSO₃) generally refers to a sulfuric acid solution of sulfur trioxide, more specifically a sulfuric acid solution of sulfur trioxide having a mass percentage of 20%.

According to an embodiment, said catalyst can be added to composition (H). For example, said catalyst is added to composition (H) in step (i) or before starting step (ii).

Alternatively, said catalyst can be generated in situ. For example, the catalyst is generated in situ as step (ii) proceeds.

Optionally, at least one additional substance can be present in step (ii). For example, such at least one additional substance can facilitate the synthesis of HCSI. According to one embodiment, said at least one additional substance can be added in step (ii). Alternatively or at the same time, said at least one additional substance is in admixture with the starting material(s), preferably with CSI and/or CSA provided under step (ii).

The amount of the at least one additional substance is not limited. Preferably, the amount of said at least one additional substance is calculated based on the reaction conditions and on the selected starting material(s).

According to a preferred embodiment, said at least one additional substance is water. Such water can be present in trace amounts in the reactor and/or one or more of the starting material(s), in particular in chlorosulfonic acid (CSA).

Preferably, the weight ratio of water to composition (H) is from 0.0001:1 to 0.001:1.

Without being bound by any theory, the Applicant believes that the presence of water in the reactor generates sulfuric acid, optionally in the presence of other by-products, which in turn acts as a catalyst.

Preferably, step (ii) is performed by heating at a temperature of at least 40° C. and of at most 150° C., preferably of at least 60° C. and more preferably of at least 80° C. More preferably, said heating is performed at a temperature from 115° C. to 145° C. and even more preferably from 120° C. to 140° C.

The heating time in step (ii) is not limited. Advantageously, the heating time is determined by monitoring the conversion of chlorosulfonyl isocyanate, according to methods known in the art.

According to a preferred embodiment, the process for manufacturing hydrogen bis(chlorosulfonyl)imide (HCSI) according to the present invention comprises after step (ii), a step of:
(iii) treating said mixture (M1) to recover HCSI in an amount (HCSI-3) and a composition (C2) comprising chlorosulfonyl isocyanate in an amount (CSI-4), chlorosulfonic acid in an amount (CSA-4) and HCSI in an amount (HCSI-4) of at most 20 wt. % based on the total weight of composition (C2), wherein HCSI-3 is higher than HCSI-4.

It will be understood that, at the end of step (iii), the sum of amount HCSI-3 and amount HCSI-4 is equal to amount HCSI-2 at the end of step (ii), ±1 wt. % or less.

Preferably, step (ii) and step (iii) are performed at the same time. Alternatively, step (ii) and step (iii) are performed successively. For example, heating in step (ii) is stopped before starting step (iii).

In step (iii), the method for recovering composition (C2) and optionally HCSI from mixture (M1) obtained in step (ii) is not particularly limited.

Preferred method can be distillation.

Optimum distillation conditions (for example pressure and temperature) as well as the equipment can be properly selected to recover composition (C2) comprising CSI-4 and CSA-4 in admixture with at most 20 wt. % of HCSI.

Two or more than two distillation steps can be performed to recover composition (C2) and optionally HCSI if required by the circumstances.

For example, good results have been obtained by performing at least one distillation under reduced pressure to recover composition (C2).

More preferably, said at least one distillation is performed at a pressure between 40 and 5 mbar abs (4000 Pa and 500 Pa). More preferably, said at least one distillation is performed by keeping the distillation device at a temperature between 30° C. and 140° C.

For example, two or more distillation steps are performed in step (iii).

According to this embodiment, a first distillation is performed at a pressure between 40 and 20 mbar abs (4000 Pa and 2000 Pa).

Preferably, a further distillation is performed at a pressure between 30 and 5 mbar abs (3000 Pa and 500 Pa).

Preferably, said first distillation is performed by keeping the distillation device at a temperature between 3° and 130° C.

Preferably, said further distillation is performed by keeping the distillation device at a temperature between 4° and 160° C.

Optimum distillation conditions (for example pressure and temperature) as well as the equipment, can be properly selected to recover HCSI.

For example, good results have been obtained by performing at least one distillation under reduced pressure to recover HCSI. Preferably, said at least one distillation is performed at a pressure between 1 and 10 mbar abs (100 Pa and 1000 Pa). Preferably, said at least one distillation is performed by keeping the distillation device at a temperature between 100° C. and 160° C.

For example, good results have been obtained under the present invention when at least one distillation step is performed to recover composition (C2) and at least one distillation step is performed to recover HCSI.

Preferably, in step (ii), said composition (H) is heated in the presence of chlorosulfonyl isocyanate and chlorosulfonic acid. It will be understood that chlorosulfonyl isocyanate and chlorosulfonic acid are newly added in the process of the invention and sum up to the amounts of chlorosulfonyl isocyanate and chlorosulfonic acid already present in the reactor.

According to this embodiment, step (ii) comprises feeding to the reactor chlorosulfonyl isocyanate in an amount (CSI-2) and chlorosulfonic acid in an amount (CSA-2).

According to this embodiment, the weight ratio of composition (H) to the sum of chlorosulfonyl isocyanate in amount (CSI-2) and chlorosulfonic acid in amount (CSA-2) is of at least 0.001:1 before heating.

Preferably, the weight ratio of composition (H) to the sum of chlorosulfonyl isocyanate in amount (CSI-2) and chlorosulfonic acid in amount (CSA-2) is of at least 0.005:1, preferably at least 0.01:1 and more preferably at least 0.035:1 before heating.

Preferably, the weight ratio of composition (H) to the sum of chlorosulfonyl isocyanate in amount (CSI-2) and chlorosulfonic acid in amount (CSA-2) is of at most 1:1, preferably at most 0.75:1, preferably at most 0.50:1 and more preferably 0.35:1 before heating.

Advantageously, the weight ratio of composition (H) to the sum of chlorosulfonyl isocyanate in amount (CSI-2) and chlorosulfonic acid in amount (CSA-2) is in the range of 0.02:1 to 0.4:1, preferably 0.05:1 to 0.25:1 before heating.

Preferably, the molar ratio of chlorosulfonyl isocyanate in amount (CSI-2) and chlorosulfonic acid in amount (CSA-2) is from 1:1 to 1:20, preferably 1:1 to 1:10, more preferably 1:1 to 1:5, even more preferably 1:1 to 1:2 and most preferably 1:1 to 1:1.1.

When chlorosulfonyl isocyanate and chlorosulfonic acid are present in step (ii), the process according to the present invention preferably comprises the steps of:
(ii-a) adding chlorosulfonic acid in amount (CSA-2) to composition (H), to provide mixture (M*) and
(ii-b) adding chlorosulfonyl isocyanate in amount (CSI-2) to said mixture (M*).

Preferably, said mixture (M*) is heated before step (ii-b).

Preferably, said heating is performed at a temperature from 100° C. to 120° C.

Preferably, the temperature is maintained at 100° C. to 120° C. in step (ii-b).

Step (ii-a) can be performed by adding chlorosulfonic acid at once (also referred to as “batch mode”) or gradually (also referred to as “fed-batch mode”).

Step (ii-b) can be performed by adding chlorosulfonyl isocyanate at once or gradually.

The process of the present disclosure can be adapted for a batch, a fed-batch or a continuous mode.

Some of the steps or preferably all steps of the process according to the invention are advantageously carried out in a reactor capable of withstanding the corrosion of the reaction medium. For this purpose, corrosion-resistant materials are selected for the part of the reactor in contact with the reaction media.

Preferably, said corrosion-resistant material is selected from alloys based on molybdenum, chromium, cobalt, iron, copper, manganese, titanium, zirconium, aluminium, carbon and tungsten, commercially available under the trade name Hastelloy®, such as in particular Hastelloy® C276; alloys of nickel, chromium, iron and manganese to which copper and/or molybdenum are added, commercially available under the trade name Inconel® or Monel™, such as in particular Inconel® 600, 625 or 718.

Said corrosion-resistant material can be selected from stainless steels, such as austenitic steels and more particularly the 304, 304L, 316 or 316L stainless steels. Preferably, a steel having a nickel content of at most 22 wt. %, preferably of between 6 wt. % and 20 wt. % and more preferentially of between 8 wt. % and 14 wt. %, is used. The 304 and 304L steels have a nickel content that varies between 8 wt. % and 12 wt. %, and the 316 and 316L steels have a nickel content that varies between 10 wt. % and 14 wt. %. More preferably, 316L steels are chosen.

Said corrosion-resistant material can be a polymeric compound resistant to the corrosion of the reaction medium, which provides a coating onto the part on the reactor in contact with the reaction media. For example, mention can be made of PTFE (polytetrafluoroethylene or Teflon) or PFA (perfluoroalkyl resins).

As an alternative and more preferably, said anti-corrosion material is selected from glass, glass-lined and enamel equipment.

Preferably, before step (i), the following steps are performed:
0-a) contacting chlorosulfonyl isocyanate and chlorosulfonic acid, thus obtaining a mixture (M) comprising HCSI, chlorosulfonyl isocyanate and chlorosulfonic acid;
00-a) treating said mixture (M), thus obtaining HCSI and a composition (H) as defined above.

In such step 0-a), chlorosulfonyl isocyanate and chlorosulfonic acid are preferably contacted under heating.

Preferably, said heating is performed at a temperature from 100° C. to 160° C.

Step 0-a) and step 00-a) can be performed at the same temperature.

Alternatively, step 0-a) is performed at a temperature between 110° C. and 130° C. and step 00-a) is performed at a temperature between 120° C. and 160° C. According to an embodiment, the temperature is raised for example between 120° C. to 160° C. before starting step 00-a).

Preferably, step 00-a) is performed by maintaining the temperature between 100° C. and 160° C.

Preferably, said step 00-a) is performed by distillation.

According to an embodiment, composition (C2) obtained in step (iii) can be recovered and fed into the reactor in step (i) or step (ii), so that said composition (C2) is recycled. It will be understood that such composition (C2) is used as composition (H) in the process of the present invention.

According to this embodiment, the process according to the present invention comprises, after step (iii), the following steps:
(iv) feeding said composition (C2) to a reactor;
(v) heating said composition (C2), thus obtaining a mixture (M2) comprising HCSI in an amount (HCSI-5), chlorosulfonyl isocyanate in an amount (CSI-5) and chlorosulfonic acid in an amount (CSA-5), wherein HCSI-5 is higher than HCSI-4, CSI-5 is lower than CSI-4 and CSA-5 is lower than CSA-4;
(vi) treating said mixture (M2) to recover a composition (C3) comprising chlorosulfonyl isocyanate in an amount (CSI-7), chlorosulfonic acid in an amount (CSA-7) and HCSI in an amount (HCSI-7) of at most 20 wt. % based on the total weight of said composition (C3), and, optionally, HCSI in an amount HCSI-6, wherein HCSI-7 is lower than HCSI-5;
(vii) optionally, repeating at least once the steps (iv), (v) and (vi) by feeding composition (C3) to a reactor, heating and recovering a composition (Cx) comprising chlorosulfonyl isocyanate in an amount (CSI-x), chlorosulfonic acid in an amount (CSA-x) and HCSI in an amount (HCSI-x) of at most 20 wt. % based on the total weight of said composition (Cx), and optionally HCSI;
with the proviso that HCSI is recovered in at least one of step (vi) or (vii), wherein “x” in (Cx), (CSI-x) and (CSA-x) represents a different amount for each compound obtained each time steps (iv) to (vi) are repeated.

It will be understood that, at the end of step (vi), the sum of amount HCSI-6 and amount HCSI-7 is equal to amount HCSI-5 at the end of step (v), ±1 wt. % or less.

Each of step (ii), step (v) and step (vii) can independently be performed in the presence of chlorosulfonyl isocyanate and chlorosulfonic acid.

Preferably, said step (v) of heating, is performed in the presence of chlorosulfonyl isocyanate in an amount (CSI-6) and chlorosulfonic acid in an amount (CSA-6).

Preferably, the weight ratio of composition (C2) to the sum of chlorosulfonyl isocyanate in amount (CSI-6) and chlorosulfonic acid in amount (CSA-6) is of at least 0.001:1 before heating.

According to an alternative embodiment, composition (C2) obtained in step (iii) is recovered and fed to a suitable container. According to this embodiment, different compositions—in particular, composition (H), composition (C2), composition (C3), and any of composition (Cx) that are recovered from different reactions or reaction mixtures of isocyanate route, are fed to the same container or to different containers. Such compositions can then be combined together and fed under step (i) of the process of the present invention as composition (H).

The parameters of the process according to the present invention can be properly selected and optimised based for example on the starting material (in particular, on the amount of other compound(s) in starting CSI and CSA, e.g. their purity) and on the scale at which the process is performed, for example is the process is performed at industrial scale or at laboratory scale.

In a second aspect, the present invention relates to a method for recycling a composition comprising chlorosulfonyl isocyanate, chlorosulfonic acid and at most 20 wt. % of HCSI, said method comprising feeding said composition to a reactor, and heating said composition at a temperature of at least 40° C. and of at most 150° C., optionally in the presence of chlorosulfonyl isocyanate and chlorosulfonic acid.

Preferably, the heating is performed at a temperature from 115° C. to 145° C. and more preferably from 120° C. to 140° C.

Advantageously, the HCSI obtained at the end of the process according to the present invention is suitable for use in a subsequent process for the manufacture of bis(fluorosulfonyl)imide or a salt thereof or a salt of bis(chlorosulfonyl)imide.

Preferably, said salt is an ammonium salt or a salt with an alkaline metal or an alkaline earth metal.

According to a preferred embodiment, said salt of bis(fluorosulfonyl imide) or of bis(chlorosulfonyl)imide is selected from ammonium, sodium or lithium.

The disclosure will be now described with reference to the following examples, whose purpose is merely illustrative and not intended to limit scope of the invention.

Should the disclosure of any patents, patent applications, and publications which are incorporated herein by reference conflict with the description of the present application to the extent that it may render a term unclear, the present description shall take precedence.

### Experimental Section

### Raw Materials

Chlorosulfonyl isocyanate (ClSO₂NCO): CAS No. 1189-71-5, commercially available from Lonza Ltd. or synthesised according to known procedures.

Chlorosulfonic acid (ClSO₃H): CAS No. 7790-94-5, commercially available from Sigma Aldrich.

Composition “light fraction”: synthesised internally within Solvay.

### Testing Methods

Differential Scanning Calorimetry (DSC): For the purity determination by a DSC, ASTM E928-19 was followed with certain optimization of the conditions for the measurement. HCSI 20 sampling must be carried out under a strictly inert atmosphere using stainless steel or gold-coated pressure-tight crucibles. DSC is performed with the samples in the range of from 10 to 30 mg. The melting peak obtained after at least two melting/crystallisation cycles, and possibly up to 4 cycles, is integrated by the DSC software. As an example, the DSC method used was defined as follows: One cycle from −30° C. to 150° C. (4 melting/3 crystallizations) at 5° C./min. under N2 25 gas stream 50 mL/min (duration 4 hours and 12 minutes). As another example, the DSC apparatus from Mettler Toledo was used for the analytical development, where the software commanding the device and performing the data analysis was the STARe software, Version 11.00a (Build 4393), also from Mettler Toledo. Other DSC apparatus can be employed similarly. The crucibles and membranes used for the HCSI DSC analysis can be chosen from 30 a variety of references, including the following ones from Mettler Toledo:
HP Steel crucibles: 51140404
HP Gold-coated crucibles: 51140405
Gold-coated single-use membrane: 51140403.

The molar purity can be estimated by means of the “Purity” or “Purity Plus” functions of the software, applying the Van′t Hoff law equation. DSC purity determination can be looked on as a super melting point determination. DSC purity determination is based on the fact that the impurities lower the melting point of an eutectic system.

$${T}_{f} = {T}_{0} = \frac{{RT}_{0} {T}_{fus}}{Δ {H}_{f}} ln ( 1 - {x}_{2.} \frac{1}{F} )$$

The simplified equation is:

$${T}_{f} = {T}_{0} - \frac{{RT}_{2}^{2}}{Δ {H}_{f}} {x}_{2.} \frac{1}{F}$$

where T_{f} is the melting temperature (which, during melting, follows the liquidous temperature);
T₀ is the melting point of the pure substance;
R is the gas constant;
ΔHf is the molar heat of fusion (calculated from the peak area);
x_{2.0} is the concentration (mole fraction of impurity to be determined);
T_{fus} is the clear melting point of the impure substance;
F is the fraction melted, and In is the natural logarithm.

In both cases, the reciprocal of the fraction melted (1/F) is given by the equation:

$$\frac{1}{F} = \frac{{A}_{tot} + c}{{A}_{part} + c}$$

where Aₚₐᵣₜ is the partial area of the DSC peak;
Aₜₒₜ is the total area of the peak, and
c is the linearization factor.

### EXAMPLES

### Example 1: Synthesis of HCSI by Isocyanate Route (Comparison)

Into a pre-inerted mechanically-stirred double-jacketed 0.25 L glass stirred-tank reactor equipped with baffles, a 4-blades stirring shaft, a double-jacketed distillation head linked to a double-jacketed fraction separator, two temperature probes, the whole setup connected to a basic scrubber was loaded at room temperature chlorosulfonic acid (CSA—145.70 g). The vessel was heated at 120° C. (condenser at −10° C.). Chlorosulfonyl isocyanate (CSI—167.50 g) was added over 4 h15 using a syringe pump. The mixture was heated from 120° C. to 140° C. and maintained over 17 hours. The mixture was pre-distilled under reduced pressure (T_{boiler}=92 to 117° C.; P=30-8.5 mbar abs.=3000-8500 Pa) to isolate 18.10 g of light fraction [composition (H)](T_{head}=25-72° C.) after about 2 hours. The resulting mixture was further distilled to isolate two HCSI fractions (T_{boiler}=120 to 145° C.; T_{head}=115 to 118° C., P=about 2-4 mbar abs=200-400 Pa) after about 5-6 hours.

The mass of HCSI isolated was 196.50 g (77.6%).

A residual heavy fraction (17.13 g) was treated separately.

### Example 2: Synthesis of HCSI by Isocyanate Route with ˜10% Doping with Composition (H) According to the Invention

The same protocol as found in Example 1 was reproduced with chlorosulfonic acid (148 g), completed with 29.2 g of light fraction [composition (H)](obtained from a previous trial). Chlorosulfonyl isocyanate (170.10 g) was added over 4 h at 120° C., and the protocol was continued as described in Example 1. The resulting mixture was pre-distilled under reduced pressure (T_{boiler}=88 to 118° C.; P=28-8 mbar abs.=2800-800 Pa) to isolate 32.60 g of light fraction (T_{head}=35-70° C.) after about 2 hours. The resulting mixture was further distilled to isolate two HCSI fractions (T_{boiler}=110 to 129° C.; T_{head}=74 to 106° C., P=4 mbar abs.=400 Pa) after about 5-6 hours.

The mass of HCSI isolated was 212.20 g (82.7%).

A residual heavy fraction (12.83 g) was treated separately.

Compared to Example 1, the yield of HCSI had an increase of 5.1% by weight when doping with 10% light fraction and the residual heavy fraction decreased by about 30% by weight.

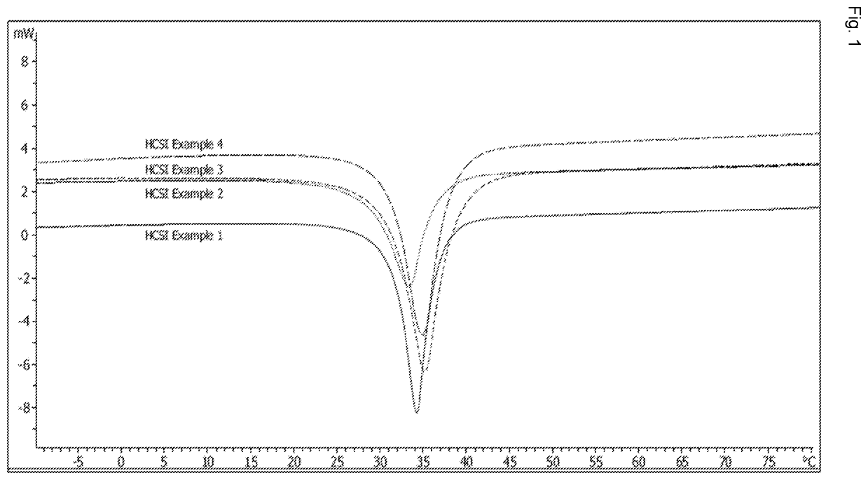

The quality of HSCI was acceptable as shown by FIG. 1.

### Example 3: Synthesis of HCSI by Isocyanate Route with ˜20% Doping with Composition (H) According to the Invention

The same protocol as found in Example 1 was reproduced with chlorosulfonic acid (143 g), completed with 62.80 g of light fraction [composition (H)](combined from 3 different previous trials). Chlorosulfonyl isocyanate (165.40 g) was added over 4 h at 120° C., and the protocol was continued as described in Example 1. The resulting mixture was pre-distilled under reduced pressure (T_{boiler}=83 to 115° C.; P=29-7 mbar abs.=2900-700 Pa) to isolate 41.00 g of light fraction (T_{head}=31-78° C.) after about 2 hours. The resulting mixture was further distilled to isolate two HCSI fractions (T_{boiler}=110 to 111° C.; T_{head}=91 to 102° C., P=3-5 mbar abs=300-500 Pa) after about 5-6 hours.

The mass of HCSI isolated was 226.60 g (90.8%).

A residual heavy fraction (16.90 g) was treated separately.

Compared to Example 1, the yield of HCSI had an increase of 13.2% by weight when doping with 10% light fraction and the residual heavy fraction decreased by about 6% by weight.

The quality of HSCI was acceptable as shown by FIG. 1.

### Example 4: Synthesis of HCSI from 100% of Composition (H) According to the Invention

Into the same vessel as described in Example 1, 336.3 g of combined light fractions (combined from 3 different previous trials) were heated following the same temperature ramp as in Example 1. The resulting mixture was pre-distilled under reduced pressure to isolate a first light fraction (143.4 g, T_{boiler}=50 to 97° C., T_{head}=31-78° C., P=30 mbar abs.=3000 Pa) and a second light fraction (14.9 g, T_{boiler}=96-120° C., T_{head}=40-50° C., P=7-20 mbar abs.=700-2000 Pa) after about 2 hours. The resulting mixture was further distilled to isolate a first HCSI fractions (12.3 g, T_{boiler}=113° C.; T_{head}=106° C., P=4 mbar abs=400 Pa) and a second fraction (10.6 g, T_{boiler}=110-121° C.; T_{head}=96-104° C., P=4 mbar abs=400 Pa) after about 5-6 hours. The mass of HCSI isolated was 118.3 g. A residual heavy fraction (9.1 g) was treated separately.

The quality of HSCI was acceptable as shown by FIG. 1 and thus could be directly used for synthesis of NH₄FSI as illustrated by Example 5.

### Example 5: Synthesis of NH₄FSI from HCSI from Example 4

Into a pre-dried PTFE 0.5 L mechanically-stirred reactor equipped with a 4-blades stirring shaft, 4 baffles, a PTFE condenser, an PFA-based internal tubing system connected to a thermostat (for internal heating purpose) and an insulating external layer were introduced under nitrogen stream NH₄F (76.9 g) and anhydrous EMC (303.1 g). The resulting slurry was pre-heated at 60° C. HCSI (101.5 g) obtained according to Example 4 was pre-heated at 60° C. and was introduced under molten form at constant flow rate over 1 h. After the addition, the mixture was maintained for 3 hours at 84° C. before cooling to room temperature. The suspension was transferred into a Büchner-type filter equipped with a 0.22 μm PTFE membrane under nitrogen stream. The emptied reactor was washed with additional EMC (154.5 g), further used to wash the solid cake. The resulting combined filtrate (472.1 g) showed a yield of 96.3% in NH₄FSI (88.9 g), as measured by ¹⁹F NMR (Bruker Avance 400 NMR) using trifluoromethoxy benzene as internal standard.

1. A process for manufacturing hydrogen bis(chlorosulfonyl)imide (HCSI), said process comprising the following steps:
(i) providing to a reactor a composition (H) comprising chlorosulfonyl isocyanate in an amount (CSI-1), chlorosulfonic acid in an amount (CSA-1) and HCSI in an amount (HCSI-1) of at most 20 wt. % based on the total weight of composition (H), and
(ii) heating said composition (H), thus obtaining a mixture (M1) comprising HCSI in an amount (HCSI-2), wherein (HCSI-2) is higher than (HCSI-1).

2. The process according to claim 1, wherein said composition (H) comprises HCSI in an amount (HCSI-1) of:
at most 15 wt. % based on the total weight of composition (H); and/or
at least 0.01 wt. % of HCSI, based on the total weight of composition (H).

3. The process according to claim 1, wherein step (ii) is performed at a temperature between 40° C. and 150° C.

4. The process according to claim 1, wherein said process comprises after step (ii), a step of:
(iii) treating said mixture (M1) to recover HCSI in an amount (HCSI-3) and a composition (C2) comprising chlorosulfonyl isocyanate in an amount (CSI-4), chlorosulfonic acid in an amount (CSA-4) and HCSI in an amount (HCSI-4) of at most 20 wt. % based on the total weight of composition (C2), wherein amount (HCSI-3) is higher than amount (HCSI-4).

5. The process according to claim 4, wherein in step (iii), at least one distillation under reduced pressure is performed to recover said composition (C2).

6. The process according to claim 3, wherein said at least one distillation is performed at a pressure between 40 and 5 mbar abs (4000 Pa and 500 Pa) and/or by keeping the distillation device at a temperature between 30° C. and 140° C.

7. The process according to claim 4, wherein in step (iii) at least two distillation steps are performed to recover composition (C2).

8. The process according to claim 7, wherein:
a first distillation is performed at a pressure between 40 and 20 mbar abs (4000 Pa and 2000 Pa) and/or by keeping the distillation device at a temperature between 3° and 130° C. and
at least a further distillation is performed at a pressure between 30 and 5 mbar abs (3000 Pa and 500 Pa) and/or by keeping the distillation device at a temperature between 4° and 160° C.

9. The process according to claim 4, wherein in step (iii), at least one distillation under reduced pressure to recover HCSI is performed, performed at a pressure between 1 and 10 mbar abs (100 Pa and 1000 Pa) and/or by keeping the distillation device at a temperature between 100° C. and 160° C.

10. The process according to claim 1, wherein step (ii) is performed by feeding chlorosulfonyl isocyanate in an amount (CSI-2) and chlorosulfonic acid in an amount (CSA-2).

11. The process according to claim 10, wherein the weight ratio of composition (H) to the sum of chlorosulfonyl isocyanate in amount (CSI-2) and chlorosulfonic acid in amount (CSA-2) is of at least 0.001:1 before heating.

12. The process according to claim 10, wherein the weight ratio of composition (H) to the sum of chlorosulfonyl isocyanate in amount (CSI-2) and chlorosulfonic acid in amount (CSA-2) is
of at least 0.005:1 before heating; and/or
of at most 1:1 before heating.

13. The process according to claim 10, wherein the molar ratio of chlorosulfonyl isocyanate in amount (CSI-2) and chlorosulfonic acid in amount (CSA-2) is from 1:1 to 1:20.

14. The process according to claim 1, wherein said process comprises, before step i), the steps of:
0-a) contacting chlorosulfonyl isocyanate and chlorosulfonic acid, thus obtaining a mixture (M*); and
00-a) treating said mixture (M*), thus obtaining HCSI and a composition (H) comprising chlorosulfonyl isocyanate in an amount (CSI-1), chlorosulfonic acid in an amount (CSA-1) and HCSI in an amount (HCSI-1) of at most 20 wt. % based on the total weight of composition (H).

15. The process according to claim 4, wherein said process comprises, after step (iii), the following steps:
(iv) feeding said composition (C2) to a reactor;
(v) heating said composition (C2), thus obtaining a mixture (M2) comprising HCSI in an amount (HCSI-5), chlorosulfonyl isocyanate in an amount (CSI-5) and chlorosulfonic acid in an amount (CSA-5), wherein HCSI-5 is higher than HCSI-4, CSI-5 is lower than CSI-4 and CSA-5 is lower than CSA-4;
(vi) treating said mixture (M2) to recover a composition (C3) comprising chlorosulfonyl isocyanate in an amount (CSI-7), chlorosulfonic acid in an amount (CSA-7) and HCSI in an amount (HCSI-7) of at most 20 wt. % based on the total weight of said composition (C3), and, optionally, HCSI in an amount HCSI-6, wherein HCSI-7 is lower than HCSI-5;
(vii) optionally, repeating at least once the steps (iv), (v) and (vi) by feeding composition (C3) to a reactor, heating and recovering a composition (Cx) comprising chlorosulfonyl isocyanate in an amount (CSI-x), chlorosulfonic acid in an amount (CSA-x) and HCSI in an amount (HCSI-x) of at most 20 wt. % based on the total weight of said composition (Cx), and optionally HCSI;
with the proviso that HCSI is recovered in at least one of step (vi) or (vii),
wherein “x” in (Cx), (CSI-x) and (CSA-x) represents a different amount for each compound obtained each time steps (iv) to (vi) are repeated.

16. The process according to claim 15, wherein under step (v), composition (C2) is heated in the presence of chlorosulfonyl isocyanate in an amount (CSI-6) and chlorosulfonic acid in an amount (CSA-6) and the weight ratio of composition (C2) to the sum of chlorosulfonyl isocyanate in amount (CSI-6) and chlorosulfonic acid in amount (CSA-6) is of at least 0.001:1 before heating.

17. A method for recycling a composition comprising chlorosulfonyl isocyanate, chlorosulfonic acid and at most 20 wt. % of HCSI, said method comprising feeding said composition to a reactor, and heating said composition at a temperature between 40° C. and 150° C., optionally in the presence of chlorosulfonyl isocyanate and chlorosulfonic acid.
